(19) United States
(12) Patent Application Publication
(10) Pub. No.: US 2024/0011474 A1
(43) Pub. Date: Jan. 11, 2024

(54) LIQUID HYDROGEN PUMP

(71) Applicant: TOYOTA JIDOSHA KABUSHIKI KAISHA, Aichi-ken (JP)

(72) Inventor: Naoaki ITO, Kariya-shi (JP)

(21) Appl. No.: 18/320,207

(22) Filed: May 19, 2023

(30) Foreign Application Priority Data
Jul. 5, 2022 (JP) 2022-108467

(51) Int. Cl. F04B 15/00; F04B 19/22; F04B 53/10

(52) U.S. Cl. CPC F04B 15/00; F04B 19/22; F04B 53/10

(57) ABSTRACT

A liquid hydrogen pump for pumping liquid hydrogen stored in a hydrogen tank by pressurizing the liquid hydrogen is provided with a cylinder at least partially disposed in the hydrogen tank, a piston reciprocating inside the cylinder, the inside of the cylinder being pressurized by the piston, and a piston separating the inside of the cylinder from a pump chamber pressurized by the piston and an opposing chamber located on the opposite side of the pump chamber with the piston interposed therebetween, and a portion corresponding to the opposing chamber of the peripheral wall of the cylinder is formed with a recirculation opening for returning the liquid hydrogen flowing into the opposing chamber into the hydrogen tank.

### CROSS-REFERENCE TO RELATED APPLICATION

This application claims priority to Japanese Patent Application No. 2022-108467 filed on Jul. 5, 2022, incorporated herein by reference in its entirety.

### BACKGROUND

### 1. Technical Field

The present specification discloses a liquid hydrogen pump that pressurizes and pumps liquid hydrogen stored in a tank.

### 2. Description of Related Art

There is hitherto known a liquid hydrogen pump that pressurizes and pumps liquid hydrogen stored in a tank. Examples of such a liquid hydrogen pump include a cylinder pump having a cylinder and a piston that reciprocates in the cylinder. In this case, a seal ring is provided on the outer peripheral surface of the piston so as to be in close contact with the inner peripheral surface of the cylinder and to restrict the passage of the liquid hydrogen.

### SUMMARY

However, even when a large number of seal rings are provided, when the liquid hydrogen is pressurized to a high pressure, a part of the liquid hydrogen to be pressurized may pass through the seal rings and leak out of the tank.

WO 2006/003871 discloses a booster pump having a cylinder including a pressurizing chamber, a reciprocating piston, and a bellows. The piston has a piston advancing and retracting in the pressurizing chamber and a piston rod. The bellows is attached to the piston, and the bellows separates the pressurizing chamber into a space surrounding the piston rod and a space outside the space. According to this configuration, even if the gap between the piston and the cylinder is increased, leakage of the liquid to be boosted can be prevented.

However, in WO 2006/003871, a bellows having high flexibility is provided in the pressurizing chamber. Therefore, the pressure fluctuation caused by the movement of the piston is absorbed by the deformation of the bellows, and there is a possibility that the target liquid cannot be pressurized to a sufficiently high pressure. That is, conventionally, there has been no liquid hydrogen pump capable of appropriately pressurizing the liquid hydrogen while preventing unintended leakage of the liquid hydrogen.

Therefore, the present specification discloses a liquid hydrogen pump capable of appropriately pressurizing the liquid hydrogen while preventing unintended leakage of the liquid hydrogen.

A liquid hydrogen pump disclosed in the present specification is a liquid hydrogen pump that pressurizes and pumps liquid hydrogen stored in a tank, and includes: a cylinder at least partially disposed in the tank; and a piston that reciprocates inside the cylinder and that separates an inside of the cylinder into a pump chamber pressurized with the piston and a facing chamber located at an opposite side to the pump chamber across the piston. A recirculation opening for returning the liquid hydrogen flowing into the facing chamber to an inside of the tank is provided in a portion of a peripheral wall of the cylinder corresponding to the facing chamber.

With this configuration, even when the liquid hydrogen flows from the pump chamber into the facing chamber, the liquid hydrogen returns from the recirculation opening into the tank, so that the external leakage of the liquid hydrogen can be effectively prevented.

In this case, the recirculation opening may be located above a liquid level when the liquid hydrogen is fully filled.

With this configuration, a large amount of liquid hydrogen is prevented from flowing from the tank into the facing chamber.

The liquid hydrogen pump may further include: an inlet provided in the pump chamber; an outlet provided in the pump chamber; a first check valve that opens and closes the inlet to allow a flow flowing into the pump chamber and prohibit a flow flowing out of the pump chamber; and a second check valve that opens and closes the outlet to allow a flow flowing out of the pump chamber and prohibit a flow flowing into the pump chamber.

With this configuration, the liquid hydrogen can be appropriately pumped.

In this case, the tank may include a collector portion locally recessed at a bottom of the tank, and the inlet may be located in the collector portion.

With this configuration, even if the remaining amount of the liquid hydrogen in the tank decreases, the liquid hydrogen can be pumped by the liquid hydrogen pump.

According to the technology disclosed in this specification, the liquid hydrogen flowing into the facing chamber beyond the piston is returned from the recirculation opening into the tank. Accordingly, it is possible to effectively prevent the liquid hydrogen from leaking out of the tank. As a result, the liquid hydrogen can be appropriately pressurized while preventing unintended leakage of the liquid hydrogen.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view of a hydrogen tank fitted with a liquid hydrogen pump;

FIG. 2 is a cross-sectional view of the main part of a liquid hydrogen pump;

FIG. 3 is a cross-sectional view showing the movement of a liquid hydrogen pump; and

FIG. 4 is a cross-sectional view illustrating another exemplary liquid hydrogen pump.

### DETAILED DESCRIPTION OF EMBODIMENTS

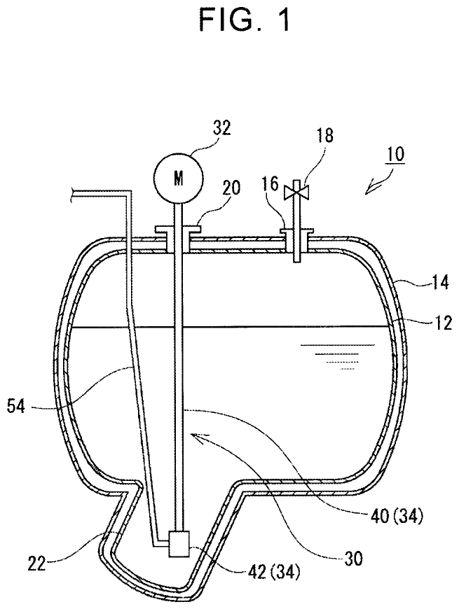

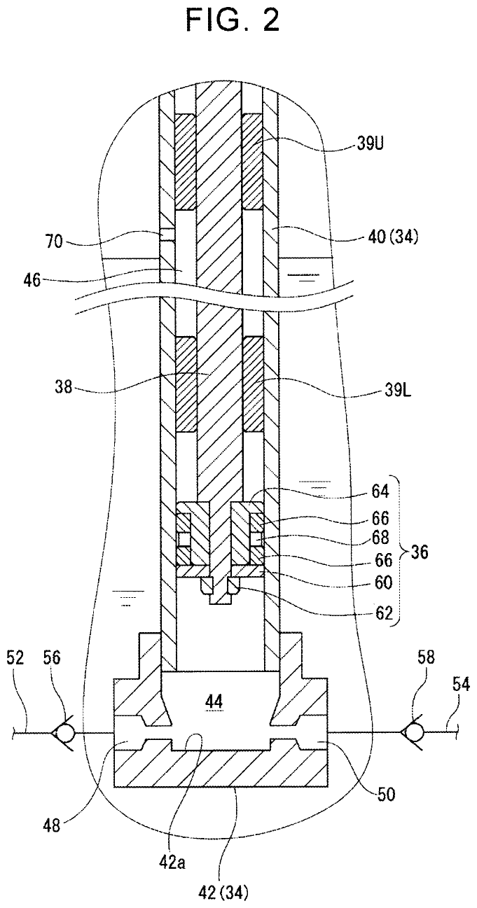

Hereinafter, the configuration of the liquid hydrogen pump 30 will be described with reference to the drawings. FIG. 1 is a schematic view of a hydrogen tank 10 to which a liquid hydrogen pump 30 is attached. FIG. 2 is a cross-sectional view of a main part of the liquid hydrogen pump 30.

The hydrogen tank 10 and the liquid hydrogen pump 30 of the present example are mounted in a vehicle using hydrogen as an energy source, for example, a hydrogen engine vehicle or a fuel cell vehicle. The hydrogen tank 10 is a tank for storing hydrogen in a liquid state. The hydrogen tank 10 stores the liquid hydrogen at a pressure equal to or slightly higher than the atmospheric pressure, for example, 1 Mpa or lower. The hydrogen tank 10 has a heat insulating structure in order to maintain the liquid hydrogen at a low temperature (−253° C. or less). Specifically, the hydrogen tank 10 includes an inner tank 12 that stores the liquid hydrogen pump 30 and an outer tank 14 that covers the inner tank 12 from the outside. A gap between the inner tank 12 and the outer tank 14 is vacuum-sucked, and this gap functions as a vacuum heat insulating layer. Each of the inner tank 12 and the outer tank 14 is made of a metal, for example, stainless steel, which is less likely to cause low-temperature brittleness.

At the bottom of the hydrogen tank 10, a collector portion 22 recessed from the periphery is provided. The cylinder head 42 of the liquid hydrogen pump 30, which will be described later, is located in the collector portion 22. The reason for this configuration will be described later.

A safety port 16 and a pump port 20 are formed at the top of the hydrogen tank 10. The safety port 16 is a port to which the boil-off valve 18 is connected. The boil-off valve 18 is a valve that discharges boil-off gas. That is, although the hydrogen tank 10 has a high heat insulating property, the liquid hydrogen is vaporized by natural heat input over time, and hydrogen gas, that is, boil-off gas is generated. If the boil-off gas is kept standing, the internal pressure of the hydrogen tank 10 excessively increases. Therefore, when the internal pressure of the hydrogen tank 10 becomes equal to or higher than a certain value, the boil-off valve 18 is opened, and the boil-off gas is discharged to the outside of the tank.

A cylinder 34 of the liquid hydrogen pump 30 is inserted into the pump port 20. The liquid hydrogen pump 30 is a booster pump that pressurizes and pumps up the liquid hydrogen. The pumped-up liquid hydrogen is vaporized by a vaporizer (not shown) provided outside the hydrogen tank 10, converted into hydrogen gas, and then directly injected into the cylinder of the hydrogen engine. In the present embodiment, the liquid hydrogen pump 30 boosts the liquid hydrogen in the tank to a high pressure (for example, 5 Mpa to 30 Mpa). In this way, pressurizing the liquid hydrogen pump 30 to a high pressure is to obtain a high-pressure hydrogen gas. That is, the hydrogen gas injected into the direct injection type hydrogen engine is required to have a very high pressure. In order to obtain such a high-pressure hydrogen gas, it is necessary to vaporize the high-pressure liquid hydrogen. However, when the liquid hydrogen is stored in the hydrogen tank 10 in a high-pressure state, it is necessary to increase the pressure resistance performance of the hydrogen tank 10, which leads to an increase in weight and cost. On the other hand, in the present example, the liquid hydrogen is stored in the hydrogen tank 10 at a low pressure, and the necessary liquid hydrogen is pressurized by the liquid hydrogen pump 30 and sent to the vaporizer. With such a configuration, it is possible to supply high-pressure liquid hydrogen to the vaporizer and obtain high-pressure hydrogen gas while keeping the pressure resistance performance required for the hydrogen tank 10 low.

The liquid hydrogen pump 30 includes a cylinder 34, a piston 36 that reciprocates inside the cylinder 34, and a pump motor 32 that reciprocates the piston 36. As shown in FIG. 2, the cylinder 34 has a cylindrical cylinder body 40 and a cylinder head 42 attached to the lower end of the cylinder body 40. The cylinder head 42 is formed with a recessed portion 42a connected to the inner space of the cylinder body 40.

The piston 36 is a member having an outer diameter substantially the same as the inner diameter of the cylinder 34. The piston 36 separates the internal space of the cylinder 34 into a pump chamber 44 and a facing chamber 46. Specifically, the lower side of the piston 36 is a pump chamber 44 pressurized by the piston 36, and the upper side of the piston 36 is a facing chamber 46. As the piston 36 reciprocates, the volume of the pump chamber 44, and thus the pressure in the pump chamber 44, changes. As a result, the liquid hydrogen in the tank is sucked into the pump chamber 44, and the sucked liquid hydrogen is pumped from the pump chamber 44 to the outside.

The configuration of the piston 36 is not particularly limited as long as it can slide in liquid-tight contact with the inner surface of the cylinder 34. The piston 36 of the present example includes an adapter ring 64, an end plate 60, a nut 62, a seal ring 66, and a spacer 68. The adapter ring 64 is a cylindrical member into which the piston rod 38 is inserted, and a flange portion is formed at an upper end thereof. The end plate 60 is an annular disc member through which the piston rod 38 can be inserted, and is disposed below the adapter ring 64. Two seal rings 66 and spacers 68 are attached to the outer peripheral surface of the adapter ring 64. The seal ring 66 is in close contact with the inner circumferential surface of the cylinder 34 to inhibit the passage of the liquid hydrogen. The seal ring 66 and the spacer 68 are vertically sandwiched between the flange portion and the end plate 60 of the adapter ring 64. The nut 62 is screwed into a male screw formed at the lower end of the piston rod 38, and tightens the end plate 60 in a direction to be brought into close contact with the adapter ring 64. Note that the configuration described here is an example, and the piston 36 may have other configurations as long as the pump chamber 44 can be appropriately pressurized and depressurized.

A piston rod 38 is connected to the piston 36. The piston rod 38 extends to the outside of the hydrogen tank 10. An upper bearing 39U and a lower bearing 39L are provided in the upper part of the piston 36, that is, in the facing chamber 46. The piston rod 38 is supported by the upper bearing 39U and the lower bearing 39L so as to be movable forward and backward.

The pump motor 32 is a motor that reciprocates the piston rod 38 and thus the piston 36. A cam (not shown) is attached to an output shaft of the pump motor 32, and the cam rotates as the pump motor 32 is driven. The piston rod 38 is biased by a spring (not shown) in a direction in contact with the cam. Therefore, as the pump motor 32 is driven, the height of the contact point between the cam and the piston rod 38 changes, and thereby the piston 36 reciprocates. Note that such a configuration is also an example, and the configuration of the actuator that reciprocates the piston 36 may be changed as appropriate. For example, instead of an actuator having a motor and a cam, an actuator having a ball screw mechanism, a hydraulic mechanism, an electromagnetic cylinder, or the like may be employed.

As described above, a pump chamber 44 is formed in a lower portion of the cylinder 34. An inlet 48 and an outlet 50 are formed in the pump chamber 44. The inlet 48 is an opening that communicates with the inside of the tank via the inflow passage 52. The outlet 50 is an opening that communicates with the outside of the tank via the outflow passage 54. Both the inlet 48 and the outlet 50 are located below the piston 36 at the bottom dead center, and are formed in a position not closed by the piston 36. Further, in the present example, the pump chamber 44 and thus the inlet 48 are located inside the collector portion 22. With this configuration, even if the remaining amount of the liquid hydrogen in the hydrogen tank 10 decreases, the liquid hydrogen can be pumped up from the inlet 48.

Here, the inlet 48 is opened and closed by the first check valve 56. The first check valve 56 allows flow into the pump chamber 44 and inhibits flow out of the pump chamber 44. Further, the outlet 50 is opened and closed by the second check valve 58. The second check valve 58 allows flow out of the pump chamber 44 and inhibits flow into the pump chamber 44. The second check valve 58 allows the flow flowing out of the pump chamber 44, but is not opened when the pressure in the pump chamber 44 is low, and the flow in the outflow direction does not occur. The second check valve 58 is opened only when the pressure in the pump chamber 44 reaches the target boost pressure.

The portion of the liquid hydrogen pump 30 that comes into contact with the liquid hydrogen is made of a material that does not cause low-temperature brittleness. Specifically, the cylinder 34, the adapter ring 64, the end plate 60, the nut 62, the spacer 68, and the piston rod 38 are made of a metal such as stainless steel, and the seal ring 66 is made of a resin that does not cause low-temperature brittleness.

The operation of the liquid hydrogen pump 30 having the above-described configuration will be described. When the piston 36 rises with the driving of the pump motor 32, the volume of the pump chamber 44 expands, and the liquid hydrogen inside the hydrogen tank 10 flows into the pump chamber 44. Thereafter, when the piston 36 is lowered as the pump motor 32 is driven, the volume of the pump chamber 44 is reduced. At this time, since the second check valve 58 is closed until a predetermined target pressure increase pressure is reached, the liquid hydrogen cannot flow out from the inside of the pump chamber 44 and is pressurized. Thereafter, when the liquid hydrogen in the pump chamber 44 is pressurized to the target pressurizing pressure, the second check valve 58 is opened, and the pressurized liquid hydrogen is pumped out of the tank through the outflow passage 54.

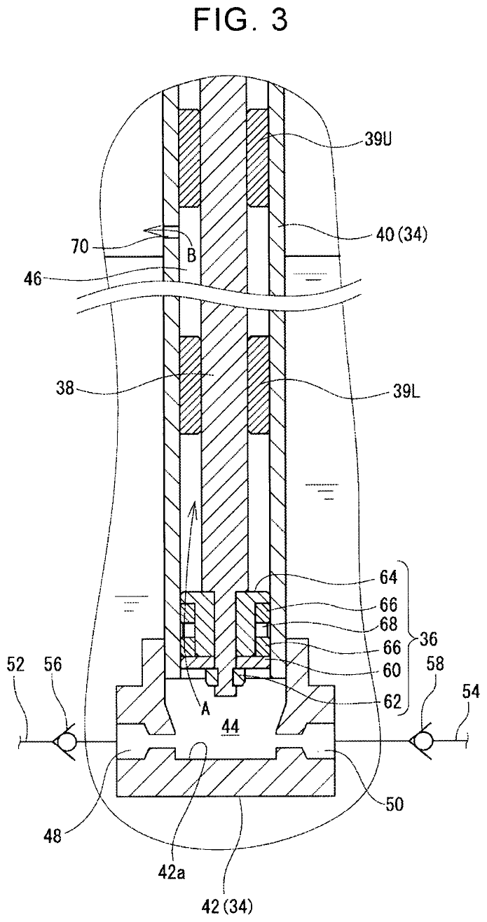

In the present embodiment, the target boost pressure is a very high pressure (e.g., 5 Mpa to 30 Mpa). Therefore, when the liquid hydrogen is pressurized, the liquid hydrogen cannot withstand the pressure of the liquid hydrogen, and a part of the piston 36 is deformed or the like, so that the liquid hydrogen sometimes flows from the pump chamber 44 into the facing chamber 46. That is, some of the liquid hydrogen may flow into the facing chamber 46 through the route of arrow A in FIG. 3. If the liquid hydrogen flowing into the facing chamber 46 eventually leaks to the outside of the hydrogen tank 10, various problems arise.

To avoid such problems, it is also conceivable to increase the number of seal rings 66. However, when the seal ring 66 is increased, other problems such as an increase in cost and an increase in the size of the pump are caused. Further, as described above, the liquid hydrogen is pressurized to a very high pressure. In addition, since the liquid hydrogen is at a very low temperature, the elasticity of the seal ring 66 in contact with the liquid hydrogen is likely to decrease, and it is difficult to keep the seal performance of the seal ring 66 high. Therefore, even if the number of seal rings 66 is increased, it is difficult to reliably prevent the liquid hydrogen from flowing into the facing chamber 46.

Therefore, in the present embodiment, the cylinder 34 is provided with a recirculation opening 70 for returning the liquid hydrogen flowing into the facing chamber 46 to the inside of the hydrogen tank 10. As shown in FIG. 2, the recirculation opening 70 is an opening formed in the circumferential surface of the cylinder 34. The recirculation opening 70 is located above a liquid level (hereinafter referred to as “top liquid level HL”) that is considered to be filled with liquid hydrogen. Further, the recirculation opening 70 is positioned at a height that is the inside of the hydrogen tank 10. Therefore, the recirculation opening 70 is located in the tank, but not in the liquid of the liquid hydrogen, and is always located in the gas. Therefore, the liquid hydrogen is prevented from flowing into the facing chamber 46 through the recirculation opening 70.

By providing the recirculation opening 70, the liquid hydrogen flowing into the facing chamber 46 returns from the recirculation opening 70 into the tank through the route indicated by the arrow B in FIG. 3 before flowing out of the tank. That is, according to the present embodiment, it is possible to effectively prevent the liquid hydrogen from leaking out of the tank while pressurizing the liquid hydrogen to a high pressure. A lower bearing 39L is located between the piston 36 and the recirculation opening 70. However, the lower bearing 39L is intended to prevent the inclination of the piston rod 38, and the gap between the lower bearing 39L and the piston rod 38 and the gap between the lower bearing 39L and the inner peripheral surface of the cylinder 34 are hardly sealed. Therefore, the liquid-hydrogen flowing into the facing chamber 46 beyond the piston rod 38 can relatively easily reach the recirculation opening 70 beyond the lower bearing 39L.

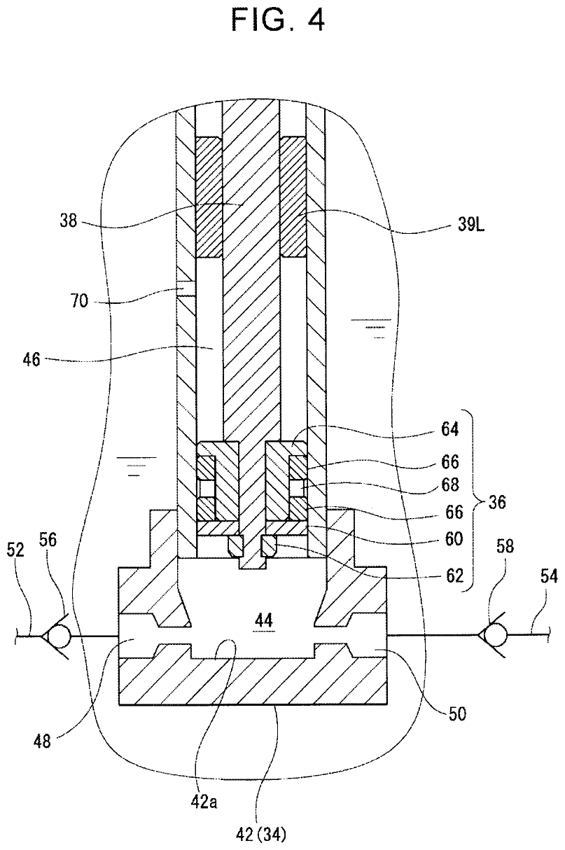

In this embodiment, the recirculation opening 70 is positioned above the uppermost liquid level HL. However, the recirculation opening 70 may be located below the uppermost liquid level HL as long as it is located above the piston 36 at the top dead center. That is, as shown in FIG. 4, the recirculation opening 70 may be positioned in the liquid. Even in this case, the liquid hydrogen flowing into the facing chamber 46 can be returned to the inside of the hydrogen tank 10 via the recirculation opening 70, and thus external leakage of the liquid hydrogen can be prevented. Here, a sealing mechanism may be provided between the lower bearing 39L and the piston 36 and between the lower bearing 39L and the cylinder 34 so that the liquid-hydrogen does not move upward from the lower bearing 39L. Since the space between the piston 36 and the lower bearing 39L has a low pressure, if there is a certain degree of sealing property, it is possible to prevent the liquid-hydrogen from moving upward beyond the lower bearing 39L.

In addition, any of the above descriptions is an example, and other configurations may be changed as appropriate as long as the recirculation opening 70 is formed at a position corresponding to the facing chamber 46 in the peripheral wall of the cylinder 34.

What is claimed is:

1. A liquid hydrogen pump for pressurizing and pumping liquid hydrogen stored in a tank, the liquid hydrogen pump comprising:
a cylinder at least partially disposed in the tank; and
a piston that reciprocates inside the cylinder and that separates an inside of the cylinder into a pump chamber pressurized with the piston and a facing chamber located at an opposite side to the pump chamber across the piston, wherein a recirculation opening for returning the liquid hydrogen flowing into the facing chamber to an inside of the tank is provided in a portion of a peripheral wall of the cylinder corresponding to the facing chamber.

2. The liquid hydrogen pump according to claim 1, wherein the recirculation opening is located above a liquid level when the liquid hydrogen is fully filled.

3. The liquid hydrogen pump according to claim 1, further comprising:
an inlet provided in the pump chamber;
an outlet provided in the pump chamber;
a first check valve that opens and closes the inlet to allow a flow flowing into the pump chamber and prohibit a flow flowing out of the pump chamber; and
a second check valve that opens and closes the outlet to allow a flow flowing out of the pump chamber and prohibit a flow flowing into the pump chamber.

4. The liquid hydrogen pump according to claim 3, wherein
the tank includes a collector portion locally recessed at a bottom of the tank, and
the inlet is located in the collector portion.
